(19) United States
(12) Patent Application Publication
(10) Pub. No.: US 2021/0174386 A1
(43) Pub. Date: Jun. 10, 2021

(54) PAYMENT APPLICATION AND METHOD

(71) Applicant: Anthony Cuzzetto, Burnaby (CA)

(72) Inventor: Anthony Cuzzetto, Burnaby (CA)

(21) Appl. No.: 16/709,888

(22) Filed: Dec. 10, 2019

(51) Int. Cl. G06Q 30/02; G06F 16/25; G06Q 10/10; G06Q 30/06; G06Q 20/28; G06K 19/06

(52) U.S. Cl. CPC G06Q 30/0236; G06F 16/252; G06Q 10/1093; G06K 19/06037; G06Q 30/0641; G06Q 20/28; G06Q 30/0633

(57) ABSTRACT

A software application that is operable to register a plurality of consumers and businesses wherein the software application provides an ability for a consumer to host an event at a registered business. The software application provides the ability for a business to generate a product specific graphic image wherein attendees of an event can pre-purchase products and receive a product specific graphic image for redemption. The product specific graphic image can be transferred to a host of the event prior to the event occurrence. The software application of the present invention facilitates account creation and a generation of a business directory wherein the plurality of consumers can browse the business directory. The software application allows the businesses to provide promotional offers to the registered users of the software application. The software application provides the ability to transfer product specific graphic images.

### FIELD OF THE INVENTION

The present invention relates generally to monetary transfer methods, more specifically but not by way of limitation, a payment application and method that facilitates payment between a patron of an establishment such as but not limited to a night club, wherein the payment application facilitates a method of payment wherein the patron is provided an efficient technique to pay for products in advance of attending the establishment.

### BACKGROUND

Millions of individuals routinely visit establishments such as but not limited to nightclubs and bars. Conventional protocols involve patrons visiting the establishment and making selections of various products such as but not limited to drinks or food wherein the payment for the aforementioned product is rendered upon completion of the delivery thereof. Standard methods of payment involve either local currency or a bank card. This can require the consumer to either ensure they have the correct amount of currency or make sure if carrying a bank card that any limits ensure the ability to execute the necessary transaction for purchase of the products. Carrying cash is undesirable for most individuals as that presents additional safety risks especially in consideration of the conventional time and location of some night activity focused establishments.

Conventional payment methods further inhibit the establishment from being able to have value added engagement with their patrons. As the nightclub industry is very competitive, marketing to potential clients is important in order to maintain the long-term viability of the establishment. The current consumer is engrossed with their technology devices such as but not limited to smart phones and leverages the applications available thereon to execute many tasks and perform various activities. Social media applications are utilized significantly on smart phones and connect extended groups of individuals. Many clients of establishments attend for an event such as but not limited to a birthday party. While conventional social media provides a channel for individuals to notify and invite people, it does not provide an establishment to be involved and market to the attendees and make offers thereto.

It is intended within the scope of the present invention to provide a software application that facilitates a method of payment between an establishment and its clients wherein the method of the software application further provides a technique to engage clients for patronage and event attendance wherein the method of the present invention can facilitate prepayment of product and offer promotions to patrons.

### SUMMARY OF THE INVENTION

It is the object of the present invention to provide a software application operable to facilitate engagement between an establishment and patrons for marketing and product purchase wherein the method of the present invention facilitates the creation of an event for individuals to attend at a designated establishment.

Another object of the present invention is to provide a software application that facilitates the ability for a patron of an establishment to pre-pay for a product of the establishment prior to visiting the establishment wherein the establishment provides marketing of offers and items such as but not limited to product lists for a patron to view and select and pay for prior to attending the establishment.

A further object of the present invention is to provide a software application operable to facilitate engagement between an establishment and patrons for marketing and product purchase wherein the method facilitates the ability for individuals to prepay for product and provide the prepaid product as a gift to a host of an event.

Still another object of the present invention is to provide a software application that facilitates the ability for a patron of an establishment to pre-pay for a product of the establishment prior to visiting the establishment wherein the software application provides registration of both the establishment and individuals by creating accounts for each.

An additional object of the present invention is to provide a software application operable to facilitate engagement between an establishment and patrons for marketing and product purchase wherein the software application provides a menu of product items for purchase to a user of the software application of the present invention.

Yet a further object of the present invention is to provide a software application that facilitates the ability for a patron of an establishment to pre-pay for a product of the establishment prior to visiting the establishment wherein the software application utilizes a QR code or similar technology to execute the transaction of product delivery once a patron is at the establishment.

An alternate object of the present invention is to provide a software application operable to facilitate engagement between an establishment and patrons for marketing and product purchase wherein the establishment can include gratuity and similar service fees in the price of the product so as to be included within the purchase.

Still a further object of the present invention is to provide a software application that facilitates the ability for a patron of an establishment to pre-pay for a product of the establishment prior to visiting the establishment wherein the software application provides a list of registered establishments for selection by users.

An additional object of the present invention is to provide a software application operable to facilitate engagement between an establishment and patrons for marketing and product purchase wherein the software application facilitates creation of an event by a user such as but not limited to a birthday party and provides tracking of attendees thereof subsequent invitation delivery.

A further object of the present invention is to provide a software application that facilitates the ability for a patron of an establishment to pre-pay for a product of the establishment prior to visiting the establishment wherein the software application provides the ability for registered users to invite individuals to register with the software application of the present invention.

An alternative objective of the present invention is to provide a software application operable to facilitate engagement between an establishment and patrons for marketing and product purchase wherein the software application facilitates communication between a patron and the establishment for VIP events and parameters associated therewith.

Yet a further object of the present invention is to provide a software application that facilitates the ability for a patron of an establishment to pre-pay for a product of the establishment prior to visiting the establishment wherein the software application will provide a gift option list for attendees of an event to which they were invited.

An additional object of the present invention is to provide a software application operable to facilitate engagement between an establishment and patrons for marketing and product purchase that ensures payment for services and/or products of delivered to patrons upon occurrence of the event.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a schematic overview of the present invention; and

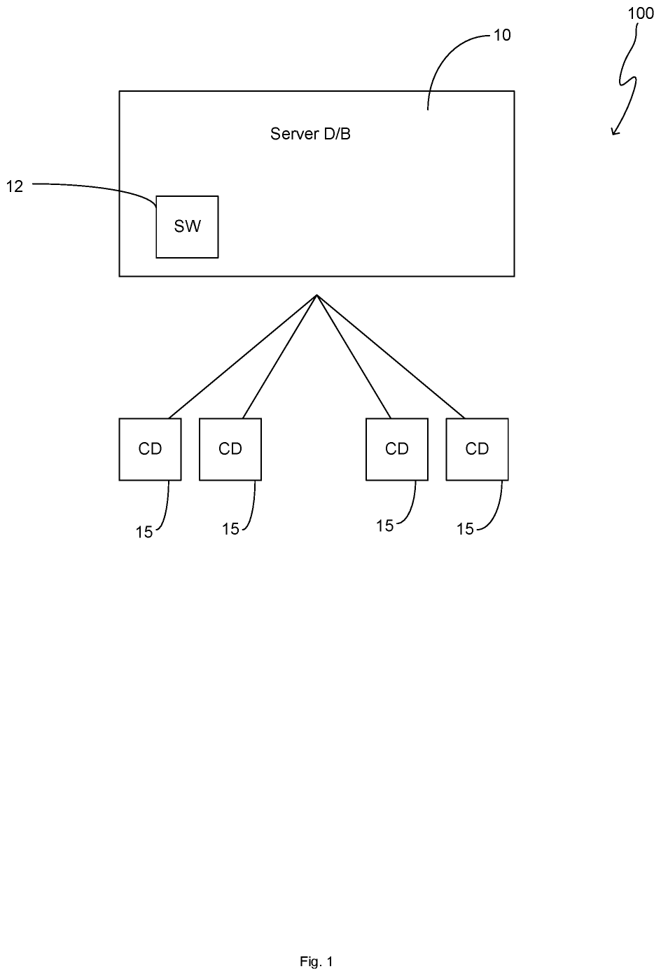

FIG. 2 is a general process workflow facilitated by the present invention; and

FIG. 3 is a flowchart of the event creation process facilitated by the present invention; and

FIG. 4 is flowchart of the event attendance process facilitated by the present invention.

### DETAILED DESCRIPTION

Referring now to the drawings submitted herewith, wherein various elements depicted therein are not necessarily drawn to scale and wherein through the views and figures like elements are referenced with identical reference numerals, there is illustrated a payment software application and method 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Now referring to the Figures submitted herewith, the payment software application and method 100 includes a server database 10 that is a conventional computing device having a database wherein the server database 10 includes the necessary electronics to receive, store, manipulate and transmit data. The server database 10 is communicably coupled to the Internet utilizing conventional communication protocols. The server database 10 has stored thereon the software application 12 of the present invention. The software application 12 is accessible via remote computing devices 15 through direct access to the server database 10 via the Internet or through services such as but not limited to application warehouses. The remote computing devices 15 are contemplated to be any computing device having operating software compatible so as to facilitate the downloading of the software application 12 and the operation thereof. It should be understood by those skilled in the art that the remote computing devices 15 could be embodied as smart phones, tablet PC or other computing devices.

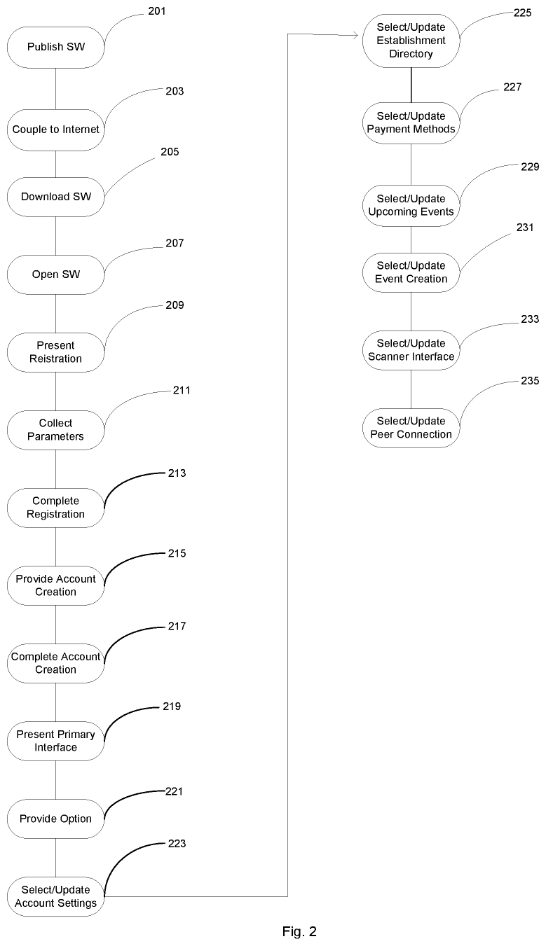

Now referring in particular to FIG. 2 submitted herewith, a general process workflow facilitated by the payment software application and method 100 is diagrammed therein. In step 201, an operator of the payment software application and method 100 will publish the software application 12 to the server database 10. Step 203, the server database 10 is communicably coupled to the Internet so as to make the software application 12 available to users. In step 205, users will download the software application 12 to their remote computing devices 15. Step 207, subsequent downloading the software application 12, a user will open the software application 12 on their remote computing device 15. In step 209, the user will be presented with the registration process. The payment software application and method 100 is operated by both individual consumers and establishments such as but not limited to nightclubs. During the registration process depending upon the entity type registering, the software application 12 will prompt for and collect general information. By way of example but not limitation, the information collected for an individual user can be name, address, confirmation of age and email contact. For an establishment parameters such as but not limited to business name, location and primary business contact are collected during the registration process. In step 211, the collected parameters are stored for each individual and/or establishment. Step 213, the registration process is completed with saving of the collected parameters

In step 215, a user and/or establishment is provided with an account creation page. The account creation page provides the ability for a user and/or establishment to enter additional data for use by the payment software application and method 100 in order to facilitate engagement therewith. The account creation page facilitates data entry for fields such as but not limited to personal/business information, profile picture, payment methods, password information, notification preferences, receipts, ordering, policies, terms and conditions of use and analytic reporting. The aforementioned parameters of the account creation page are further discussed herein. Furthermore, the aforementioned parameters of the account creation page are exemplary and it is contemplated within the scope of the present invention that the account creation page could include additional parameters. In step 217, the user or establishment will complete the account creation process and wherein a user or establishment can update any account information at any time.

In step 219, a user or establishment will login into the software application 12 ensuing registration with the payment software application and method 100 a primary interface is presented to a user or establishment during login. The primary interface is the main graphical interface for a user or establishment to engage with the software application 12. In step 221, the primary interface in a preferred embodiment presents the following categories to a user or establishment that has logged into the software application 12. The categories of account settings, establishment directory, payment methods, upcoming events, event creation, payment scanning and search engine are contemplated within the scope of a preferred embodiment of the present invention. It is contemplated within the scope of the present invention that the aforementioned categories could be added to so as to provide additional functionality. Ensuing being presented with the primary interface and the categories, the user or establishment will select account setting category in order to initiate or update the parameters thereof in step 223. Step 223 can include the entering and storing of parameters such as but not limited to personal or establishment information, profile picture, payment methods, password information, notification preferences, receipt history, ordering, terms and conditions of use, and analytic reporting. It should be understood within the scope of the present invention that step 223 could occur initially or at anytime during use of the software application 12.

In step 225, a user will select the establishment directory. The establishment directory provides users a list of all of the establishments that are registered with the payment software application and method 100. The establishment directory provides users detailed information on each registered establishment such as but not limited to location, special event and offers, website and contact information. Each registered establishment utilizes the payment software application and method 100, specifically the establishment directory, to direct market to registered users of the payment software application and method 100. In step 227, users will select payment methods and enter preferred payment information such as credit cards or electronic transfer accounts. Payment options are utilized to secure payment for orders placed within the payment software application and method 100 from a user for a particular establishment. In step 229, a user will select upcoming events to browse either events for which they have provided a RSVP or to see events to either which they have been invited or are interested in attending. Step 231, a user will select event creation to initiate the process of creating an event. The event creation process facilitated by the payment software application and method 100 is further discussed herein. In step 233, a user can select the scanner interface wherein the scanner interface presents a QR code or similar graphic wherein the establishment can scan the graphic in order to facilitate the receipt of a product from the establishment. It is contemplated within the scope of the present invention that the scanner interface present a specific image for each product type of the establishment in order to assist with accurate analytics discussed further herein. In step 235, a user can enter the search directory to search for either registered users so as to invite to an event or for non-registered users and provide a link to the non-registered users to join the payment software application and method 100. It is contemplated within the scope of the present invention that the operator of the payment software application and method 100 will provide incentive to registered users to recruit new users. It should be understood within the scope of the present invention that the step 223 through step 235 can occur at anytime and do not need to be executed in any particular order.

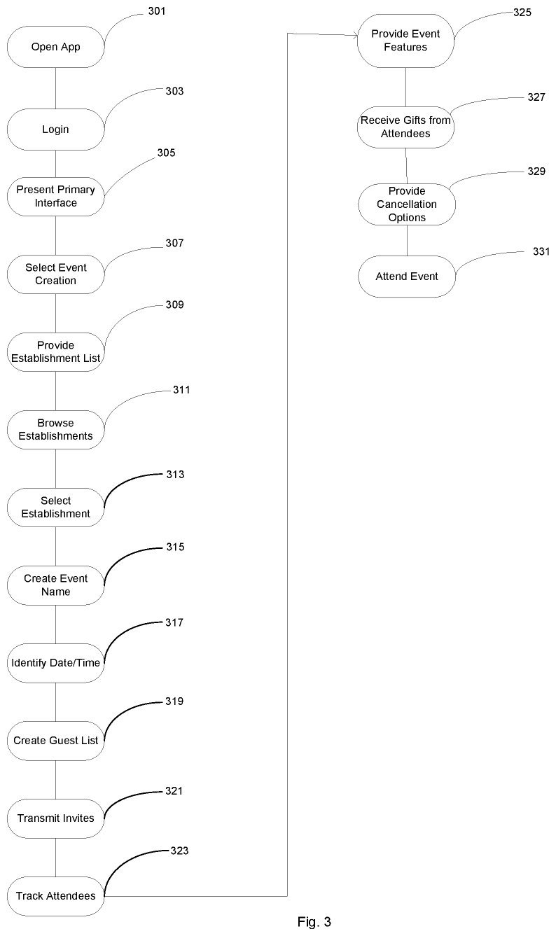

Now referring in particular to FIG. 3 submitted herewith, an exemplary process flow for an event creation is diagrammed therein. One of the primary benefits of the payment software application and method 100 is the ability to link establishments with users wherein the users can create events and pay for services and/or products offered by the establishment in advance of the event. In step 301, a user will open the software application 12 of the present invention. Step 303, a user will login into the payment software application and method 100 using a remote computing device 15. In step 305, ensuing login a user is presented the primary interface. Step 307, the user will select event creation. The event creation category will provide the ability for a user to select an establishment, create an event and invite attendees. In step 309, the user is provided with a directory of establishments to choose from to host the event. The directory will include detailed information about the establishment, any special promotions provided by the establishment as well as a menu of services and products offered by the establishment. Step 311, the user will browse the directory of establishments in order to identify a preferred establishment to host their event. In step 313, the user will select an establishment to host their event. Step 315, the user will create a name for the event such as but not limited to birthday party. In step 317, the user will specify a day and a time at which they would like the event to occur. Step 319, the user will create a guest list wherein the guest list can be created from registered users of the payment software application and method 100 and non-registered users. In step 321 the software application will transmit invitations to the selected guests as well as transmit notification to the selected establishment. It should be understood within the scope of the present invention that in the directory of establishments information about capacity and availability is provided to a user so as to ensure a user identifies an establishment that can host their desired event.

In step 323, the payment software application and method 100 will provide tracking of attendees of the event wherein invited guest who have provided an RSVP are identified to the event host. Step 325, the user is provided with event features such as but not limited to VIP service or bottle service wherein the establishment markets to the user hosting the event through the software application 12. In step 327, ensuing providing notification of attending the event, the guests can pay for gifts, wherein the gifts are products or services from the hosting establishment and transmit the gifts to the user hosting the event to be redeemed at the event. Step 329, the software application provides guests various cancellation options if they are unable to attend after providing notification of acceptance. It is contemplated within the scope of the present invention that the cancellation policy could include but is not limited to holding the value of the purchased product or service for a year for use by the purchaser for subsequent redemption at the establishment. In step 331, the user will attend the event.

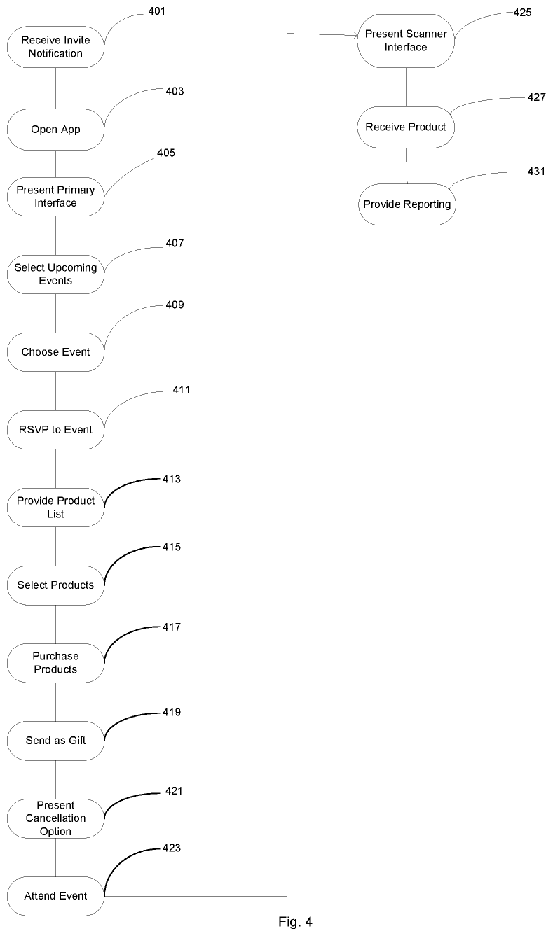

Now referring to FIG. 4, a process flow for event attendance is diagrammed therein. In step 401, a user will receive an event invitation. Step 403, the recipient of the event invitation will open the software application 12 of the present invention wherein a link thereto was embedded in the event invitation. Step 405, the invited guest is presented with the primary interface subsequent logging into the software application 12. In step 407, the invited guest will select the upcoming events category. Step 409, the invited guest will be presented and select the event to which they are responding to the invitation. Step 411, utilizing the software application, the invited guest will provide a RSVP to the host of the event so as to provide confirmation of attendance. In step 413, the invited guest will then be provided with a product and/or service list of items for purchase to be consumed or delivered at the event. The software application 12 facilitates the ability for the establishment to direct market to the invited guest during this step by providing special offers and/or promotions that can be redeemed at the event. In step 415, the user will select products whereupon ensuing selection of products a user is provide a product specific QR code or similar graphic to be stored in the software application 12 on the remote computing device 15 of the user. Step 417, the user will complete the purchase of the products using the payment method identified in the payment methods within the account categories. Step 419, the user may have purchased products/services for themselves to be redeemed at the event or may have purchased products/services to be transmitted to the host as a gift prior to the event. In the event of the latter, the software application 12 will transmit the gift to the user wherein the gift is delivered in the form of a redeemable QR code. In step 421, the payment software application and method 100 will provide cancellation options to an invited guests an various parameters such as but not limited to future redemption of purchased products/services in the event the invited guest is unable to attend.

Step 423, the invited guests will attend the event. In step 425, the user will present the product specific QR code, which will be scanned utilizing a suitable device by the establishment. Step 427, the invited guest will receive the purchased product/service. In step 431, ensuing attending events or an establishment hosting an event, a plurality of data analytics are available to each. This is to include but not limited to amount/type product sold or purchased, available balances, totals per bartender, average gratuity and number of establishments visited over a defined time period.

While process flows of the payment software application and method 100 are described herein, it should be understood within the scope of the order of the process flows and steps thereof are exemplary and could be substituted or rearranged and not deviate from the desired scope of the present invention.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A method of facilitating the selection of an establishment for hosting of an event wherein a event organizer will utilize a software application of the present invention to schedule the event wherein the method of the present invention comprises the steps of:
providing a software application, wherein said software application is loaded onto a server database, wherein said server database communicably coupled to an internet,
downloading the software application, wherein users will download the software application to a remote computing device;
registering with the software application;
creating an account within the software application;
registering establishments with the software application;
creating an event, wherein a user of the software application will create an event wherein the event is to be hosted at a registered establishment;
inviting guests to the event, wherein an event host will invite guests to the event wherein an invitation is transmitted through the software application;
presenting guests with a product or service list;
selecting at least one product or service from the product or service list;
purchasing at least one product or service from the product or service list;
receiving a product specific graphic code, wherein the product specific graphic code is stored on the remote computing device;
attending the event;
presenting the product specific graphic code; and
receiving the product or service;

2. The method as recited in claim 1, and further including the step of transmitting a purchased product or service to the event host.

3. The method as recited in claim 2, and further including the step of providing an establishment directory, wherein the establishment directory is available for browsing by users of the software application.

4. The method as recited in claim 3, and further including the step of including service fees with a product purchase.

5. The method as recited in claim 4, and further including the step of browsing upcoming events, wherein a user is presented with an event category and can obtain information about an event and an establishment where the event is located.

6. The method as recited in claim 5, and further including the step of providing an incentive to a registered user, wherein a registered user will be provided an incentive usable at an establishment.

7. The method as recited in claim 6, and further including the step of providing a cancellation policy, wherein the cancellation policy allows retention of purchased product for future use.

8. A method of connecting a plurality of users with an establishment wherein one of the plurality of users will host an event at the establishment wherein the method comprises the steps of:
providing a software application, wherein said software application is available from a server database;
registering a plurality of consumers;
registering a plurality of businesses;
creating an account, wherein said plurality of consumers and said plurality of businesses create an account utilizing the software application, wherein the account captures information about each of the plurality of consumers and each of the plurality of businesses;
generating a business directory, wherein the business directory is populated with the plurality of businesses;
browsing the business directory, wherein one of the plurality of consumers utilizes the software application to browse the business directory;
selecting a business, wherein the one of the plurality of consumers selects a business from the business directory,
creating an event, wherein the one of the plurality of consumers creates an event to be held at the business selected from the business directory;
sending invitations, wherein the one of plurality of consumers sends invitations requesting attendance of the event;
responding to the invitations, wherein consumers reply to the invitation;
purchasing products from the business selected from the business directory, wherein the consumers who replied to the invitation can purchase products from the business selected from the business directory utilizing the software application;
receiving a product specific graphic image, wherein upon purchase of a product from the business selected from the business directory the consumer will receive a graphic image to be stored on a portable computing device for redemption of the product at the business selected from the business directory;
transmitting the product specific graphic image, wherein attendees of the event can transmit the product specific graphic image to a host of the event;
attending the event, wherein the plurality of consumers who replied to the invitations go to the business selected from the business directory;
redeeming the product specific graphic image for receipt of a product.

9. The method of connecting a plurality of users with an establishment as recited in claim 8, and further including the step of presenting the product specific graphic image, wherein one of the plurality of consumers presents a product specific graphic image to an employee of the business selected from the business directory.

10. The method of connecting a plurality of users with an establishment as recited in claim 9, and further including the step of scanning the product specific graphic image.

11. The method of connecting a plurality of users with an establishment as recited in claim 11, and further including the step of including gratuity in a price for the product specific graphic image.

12. The method of connecting a plurality of users with an establishment as recited in claim 11, and further including the step of creating a guest list, wherein the guest list can be created from the registered plurality of consumers and consumers not registered with the software application of the present invention.

13. The method of connecting a plurality of users with an establishment as recited in claim 12, and further including the step of providing an incentive for recruiting a consumer to register with the software application.

14. The method of connecting a plurality of users with an establishment as recited in claim 13, and further including the step of offering special promotions to the host of the event, wherein the business selected from the business directory provides promotional offers to the host during event creation.

15. A method of connecting a plurality of users with an establishment wherein one of the plurality of users will host an event at the establishment and a host is able to receive product credits in advance of the event wherein the method comprises the steps of:
providing a software application, wherein said software application is available from a server database;
registering a plurality of consumers;
registering a plurality of businesses;
creating an account, wherein said plurality of consumers and said plurality of businesses create an account utilizing the software application, wherein the account captures information about each of the plurality of consumers and each of the plurality of businesses;
generating a business directory, wherein the business directory is populated with the plurality of businesses;
browsing the business directory, wherein one of the plurality of consumers utilizes the software application to browse the business directory;
selecting a business, wherein the one of the plurality of consumers selects a business from the business directory,
creating an event, wherein the one of the plurality of consumers creates an event to be held at the business selected from the business directory;
identifying a date for the event;
creating a name for the event;
sending invitations, wherein the one of plurality of consumers sends invitations requesting attendance of the event;
responding to the invitations, wherein consumers reply to the invitation;
purchasing products from the business selected from the business directory, wherein the consumers who replied to the invitation can purchase products from the business selected from the business directory utilizing the software application;
receiving a product specific graphic image, wherein upon purchase of a product from the business selected from the business directory the consumer will receive a graphic image to be stored on a portable computing device for redemption of the product at the business selected from the business directory;
transmitting the product specific graphic image, wherein attendees of the event can transmit the product specific graphic image to a host of the event;
attending the event, wherein the plurality of consumers who replied to the invitations go to the business selected from the business directory;
scanning the product specific graphic image, wherein the product specific graphic image is scanned by the business at which the event is occurring;
receiving a product, wherein an attendee who had a product specific graphic image scanned receives a product in exchange for redemption of a scanned product specific graphic image.

16. The method of connecting a plurality of users with an establishment as recited in claim 15, and further including the step of browsing upcoming events, wherein a user is presented with an event category and can obtain information about an event and an establishment where the event is located.

17. The method of connecting a plurality of users with an establishment as recited in claim 16, and further including the step of providing an incentive to a registered user, wherein a registered user will be provided an incentive usable at an establishment.

18. The method of connecting a plurality of users with an establishment as recited in claim 17, and further including the step of including gratuity in a price for the product specific graphic image.

19. The method of connecting a plurality of users with an establishment as recited in claim 18, and further including the step of providing a cancellation policy, wherein the cancellation policy allows retention of purchased product for future use.

20. The method of connecting a plurality of users with an establishment as recited in claim 19, and further including the step of offering special promotions to the host of the event, wherein the business selected from the business directory provides promotional offers to the host during event creation.
